(19) United States
(12) Patent Application Publication
(10) Pub. No.: US 2012/0066554 A1
(43) Pub. Date: Mar. 15, 2012

(54) APPLICATION QUERY CONTROL WITH COST PREDICTION

(75) Inventor: Marcelo Lopez Ruiz, Kirkland, WA (US)

(73) Assignee: Microsoft Corporation, Redmond, WA (US)

(21) Appl. No.: 12/878,291

(22) Filed: Sep. 9, 2010

(51) Int. Cl. G06F 9/46; G06F 11/07

(52) U.S. Cl. 714/48; 718/100; 714/E11.025

(57) ABSTRACT

Determining if access should be granted to a data source. A method includes determining resource usage cost of performing an operation on a data source. The method further includes determining if the resource usage cost exceeds a predetermined threshold. When the resource usage cost exceeds a predetermined threshold, the operation is rejected.

### BACKGROUND

### Background and Relevant Art

Computers and computing systems have affected nearly every aspect of modern living. Computers are generally involved in work, recreation, healthcare, transportation, entertainment, household management, etc.

Computer systems may contain functionality for accessing data from data sources. Applications commonly execute queries on data sources based on external input and requests. This is particularly common in distributed systems where one layer acts as an access point for a data store. For example in a classic three-tier application, the middle tier acts as gatekeeper between a client tier and a data store tier. In particular, one tier represents clients, and the middle tier may be a service that controls access by clients to a database tier.

Generally a user at a client in the client tier will request data from a service in the service tier and the data storage tier, will go and do work based on the service tier's request. As can be appreciated, systems have limited resources. Thus, systems are limited in the types and number of requests that can be handled by a particular system. In previous systems, a system might be limited in the types of requests it would handle so that system resources could not be exceeded. In particular, a request may be denied based on just the specific request itself. This constrained the system and limited the requests that could be made to a system, thus creating a constrained system. Thus, the traditional way of controlling the amount of work and system resource usage is to limit the interface to the services tier and the data storage tier itself. While this is effective, it typically severely reduces the functionality of the middle tier by limiting the number and kind of requests a client may make.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Some embodiments, include a method practiced in a computing environment. The method includes acts for determining if access should be granted to a data source. The method includes determining resource usage cost of performing an operation on a data source. The method further includes determining if the resource usage cost exceeds a predetermined threshold. When the resource usage cost exceeds a predetermined threshold, the operation is rejected.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a topology including a client system, a middle tier, and a database server;

FIG. 2 illustrates a method of determining if access should be granted to a data source; and

FIG. 3 illustrates another method of determining if access should be granted to a data source.

### DETAILED DESCRIPTION

Embodiments described herein may implement embodiments that do not specifically limit functionality based on a specific operation, such as a query or type of query, but rather provide limits based on and defined by use of resources. For example, embodiments may control and/or reject queries based on calculated resource usage resulting from the queries. Such resources may be storage device resources, such as those caused input/output (I/O) operations; processor resources such as are defined by cycles or operation; database resources such as number of database rows accessed; network resources, such as usage of network bandwidth; memory resources, etc. Embodiments may include mechanisms for an application to obtain a cost prediction for the work from a data source that performs the work, and to apply this information to allow or reject requests. This allows servers to expose a highly expressive service interface and limit the amount of work done on behalf of clients based on estimated cost and not on the nature of the query or request.

Some embodiments may use a cost prediction model to accept or reject requests at a different tier in which the cost prediction is generated. Some embodiments may obtain a cost prediction model for a work before executing it by reusing existing cost estimation infrastructure in existing systems.

When writing a networked application that provides access to a data source, users often struggle with finding the right balance between limiting access so much that they cannot fulfill the needs of their requests without constantly adding new access operations, and allowing so much flexibility that a request can cost an inordinate amount of resources to satisfy.

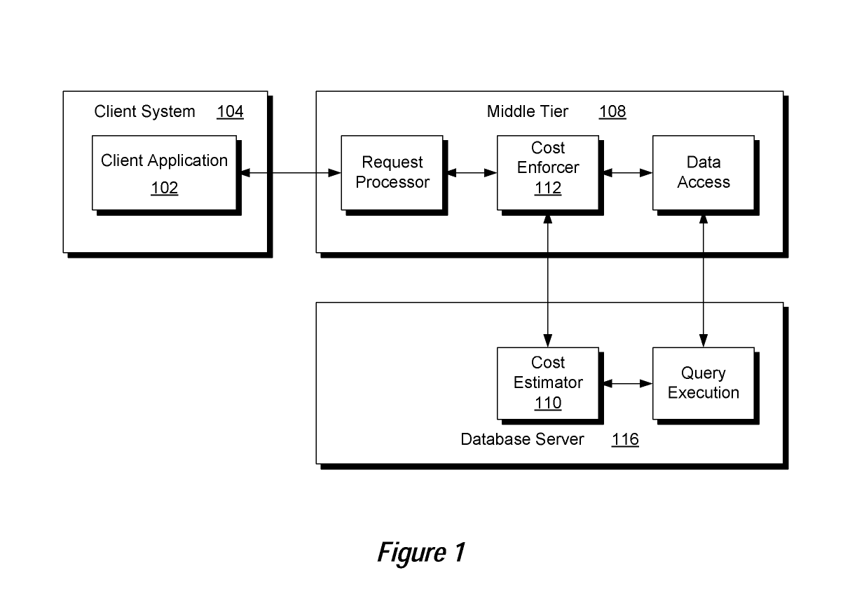

Referring now to FIG. 1, an example embodiment is illustrated. In the embodiment illustrated in FIG. 1 a client application 102 installed on a client system 104 communicates with a data store, in this example, a database server 106 through a middle tier 108 or service tier. The middle tier 108 includes a system or systems that implement services available to the client application 102.

In the illustrated example of FIG. 1, the middle-tier system 108 takes requests from clients 102, does an initial translation and analysis of the request, translates it into database terms (e.g. a SQL query) and then sends it to the database server 106 for cost estimation at a cost estimator module 110 at the database server 106 without actual execution of the request. When the cost comes back from the cost estimator 110, a cost enforcer module 112 at the middle-tier system 108 decides whether to proceed and execute the request (such as by having the SQL query executed) or reject the request due to projected resource utilization exceeding predetermined thresholds.

Some embodiments may leverage existing technology. For example, existing data stores may implement cost estimation functionality that can determine resource costs for various queries. This functionality typically exists for query optimization. In particular, a user can request some data. The request is converted to queries that are executed by the data store. Using the cost estimation functionality, selection of queries to service the request but which optimize system resources can be made. Thus, some embodiments, rather than using the cost estimation functionality for query optimization can use the cost estimation functionality to determine if a request can even be honored.

Some very specific embodiments described herein, use technology that was introduced as part of WCF (Windows Communication Foundation™) Data Services available from Microsoft® Corporation of Redmond Wash. As part of the configuration of the data service and/or at runtime, the data service developer is able to set thresholds on the estimated cost of any given query. The IQueryable objects represent client requests and are provided by an underlying data source, based in this case on on ObjectContext source, these are wrapped with another IQueryable that is aware of the thresholds, and will look up the cost prediction for the query by contacting the underlying database server 106. The cost prediction is then compared to the thresholds set for the current request, and if any limits are exceeded, an exception is thrown that informs the requesting user that the query is too expensive. Additional details may be provided when debugging settings are enabled, including which cost metrics were exceeded and what the threshold values are that are being checked against.

An example of this particular embodiment is now illustrated:

```
public class SimpleDataService : DataService<
MeasuringProvider<MyEntitiesDataSource>>
{
  public override MeasuringProvider<MyEntitiesDataSource>
  CreateDataSource( ) {
    var result = base.CreateDataSource( );
    // Possibly vary these values based on the current request (eg: sender).
    result.EstimateThresholds.MaxIO = 1d;
    result.EstimateThresholds.MaxCPU = 1d;
    result.EstimateThresholds.MaxRows = 1000;
    return result;
  }
}
```

This would result in a service that behaves as it were declared as DataService<MyEntityDataSource>, but the MeasuringProvider provides performs the interception mechanism and allows estimate thresholds to be set that will be enforced at runtime. In the above example, the query will not be serviced if cost prediction modules indicate any one of input/output operations on a storage device exceeding 100 page reads, CPU cycles exceeding 1,000,000 operations, or more than 1000 rows will be accessed as a result of the query.

While in the example illustrated above, cost estimation is performed by existing cost estimation functionality included at a data store, other embodiments may be implemented where cost estimation functionality is performed by specially created modules that are implemented in any one of a number of different locations. For example, in some embodiments, cost estimation functionality may be implemented using specialized modules at the middle tier 108. In this embodiment, the middle tier would not need to request that the database layer perform cost estimation functions. Rather, when a request is received from a client 102, the middle tier 108 can determine if the request, if serviced, would exceed various resource threshold limits.

In an alternative embodiment, embodiments may be implemented where cost estimation functionality could be implemented by using specialized modules implemented at the client system 104. The client application 102 could consult one or more specialized cost estimation modules implemented at the client machine to determine if a request would exceed resource threshold limits. In particular, the client application 102 could send the request, intended for a data store tier through a middle tier, to a specialized module on the client system 104 prior to sending to the middle tier. The request would only be sent to the middle tier if the specialized cost estimation module at the client system determined that the request if executed would not cause resource usage to be exceeded.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

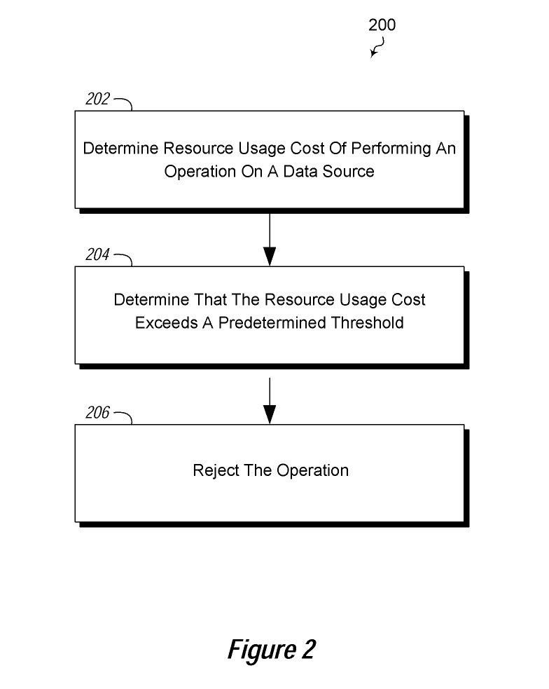

Referring now to FIG. 2, in some embodiments a method 200 may be practiced in a computing environment. The method 200 includes acts for determining if access should be granted to a data source. The method 200 includes determining resource usage cost of performing an operation on a data source (act 202). Performing an operation may include any one of a number of activities. For example, performing an operation may comprise executing a query or invoking a stored procedure. It should be noted however, that invoking a stored procedure may often be regarded as executing a query. The method 200 may be practiced where determining resource usage cost of performing an operation on a data source includes using existing cost estimation framework of data storage tiers. In particular, some database systems include functionality for determining the cost of a query. This infrastructure exists to enable these systems to restructure queries at the database. However, this infrastructure can be leveraged by embodiments described herein.

The method 200 further includes determining if the resource usage cost exceeds a predetermined threshold (act 204). When the resource usage cost exceeds a predetermined threshold, the operation is rejected (act 206).

The method 200 may be practiced where rejecting the operation includes preventing a request from being sent from a client to a data store. Alternatively or additionally, the method 200 may be practiced where rejecting the operation includes causing an error to be emitted. In some embodiment, emitting an error includes throwing an exception.

Embodiments of the method 200 may be practiced where the resource usage cost is based on usage of various hardware and/or database resources. For example, in some embodiments, the resource usage cost is based on at least one of estimated disk I/O operations, CPU operations or cycles, number of database rows that would be accessed by the operation, network resource utilization (such as bandwidth or sending/receiving operations) or memory utilization.

The method 200 may be practiced where the threshold is a static threshold for each resource. For example, a specific threshold may be set for CPU cycles, disk I/O operations and network usage. If any of these thresholds are exceeded, then the operation is rejected. Alternatively, the method 200 may be practiced where the threshold is a dynamic or formulaic threshold dependant at least on different usages of different resources. For example, higher memory usage may be allowed if a lower number of CPU cycles are used.

The method 200 may be practiced where the threshold varies according to a privilege level of a user sending a request. For example, a user with a higher privilege level may be allowed to use more resources for an operation than a user with a lower privilege level.

The method 200 may be practiced where the threshold varies according to time. For example, the threshold may vary based on what time of day, time of week, or time of year a request for an operation is made. For example, on typical low usage time periods, such as evenings, weekends or holidays, thresholds may be set higher in anticipation of less overall usage.

The method 200 may be practiced where the threshold varies according to load on a system. For example, if a database server system is under heavy usage, thresholds may be set lower as there are fewer resources available to service queries.

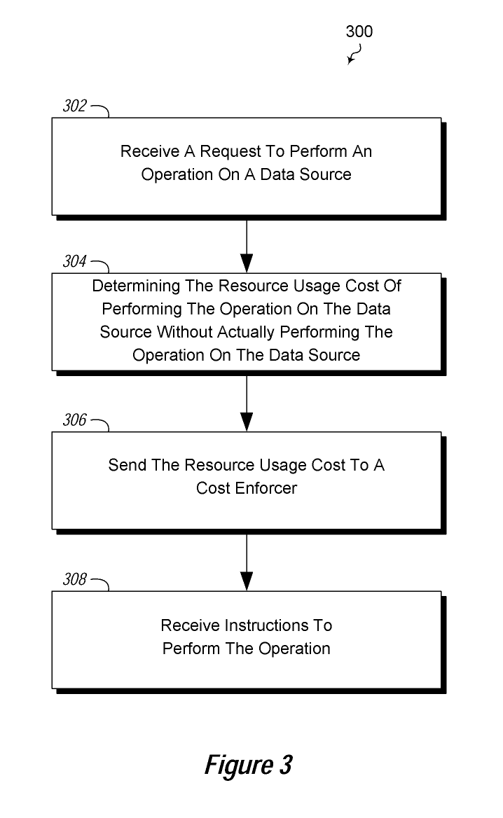

Referring now to FIG. 3, a method 300 is illustrated. The method 300 may be practiced in a computing environment and includes acts for determining if access should be granted to a data source. The method includes receiving a request to perform an operation on a data source (act 302). The database server has a cost estimator. For example, as shown in FIG. 1, a database server 116 with a cost estimator 110 may receive a query from a client application 102 at a client system 104 through the middle-tier server.

Using the cost estimator, the method 300 further includes determining resource usage cost of performing the operation on the data source, without actually performing the operation on the data source (act 304). For example, the cost estimator 110 may estimate the cost of a query (such as cost in terms of estimated disk I/O operations, CPU operations or cycles, number of database rows that would be accessed by the query, network resource utilization, and/or memory utilization).

The method 300 further includes sending the resource usage cost to a cost enforcer (act 306). When the resource usage cost is below a predetermined threshold the method includes receiving instructions to perform the operation (act 308).

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of determining if access should be granted to a data source, the method comprising:
determining resource usage cost of performing an operation on a data source;
determining if the resource usage cost of performing the operation exceeds a predetermined threshold; and
when the resource usage cost exceeds a predetermined threshold rejecting the operation.

2. The method of claim 1, wherein determining resource usage cost of performing an operation on a data source comprises using existing cost estimation framework of data storage tiers.

3. The method of claim 1, wherein rejecting the operations includes preventing a request from being sent from a client to a data store.

4. The method of claim 1, wherein rejecting the operation includes causing an error to be emitted.

5. The method of claim 4, wherein emitting an error comprises throwing an exception.

6. The method of claim 1, wherein the resource usage cost is based on usage of at least one of estimated disk I/O operations, CPU operations, number of database rows, network resource utilization or memory utilization.

7. The method of claim 1, wherein the threshold is a static threshold for each resource.

8. The method of claim 1, wherein the threshold is a dynamic or formulaic threshold dependant at least on different usages of different resources.

9. The method of claim 1, wherein the threshold varies according to a privilege level of a user sending a request.

10. The method of claim 1, wherein the threshold varies according to time, including at least one of time of day, week, or year.

11. The method of claim 1, wherein the threshold varies according to load on a system.

12. In a computing environment, a method of determining if access should be granted to a data source, the method comprising:
receiving a request to perform an operation on a data source;
using a cost estimator, determining resource usage cost of performing the operation on the data source, without actually performing the operation on the data source;
sending the resource usage cost to a cost enforcer; and
when the resource usage cost is below a predetermined threshold receiving instructions to perform the operation.

13. The method of claim 12, wherein determining resource usage cost of performing an operation on a data source comprises using existing cost estimation framework of data storage tiers.

14. The method of claim 12, wherein the resource usage cost is based on usage of at least one of estimated disk I/O operations, CPU operations, number of database rows, network resource utilization or memory utilization.

15. The method of claim 12, wherein the threshold is a static threshold for each resource.

16. The method of claim 12, wherein the threshold is a dynamic or formulaic threshold dependant at least on different usages of different resources.

17. The method of claim 12, wherein the threshold varies according to a privilege level of a user sending a request.

18. The method of claim 12, wherein the threshold varies according to time, including at least one of time of day, week, or year.

19. The method of claim 12, wherein the threshold varies according to load on a system.

20. A system for determining if access should be granted to a data source, the system comprising:
a database system configured to receive queries from a client application;
a client system configured to send database queries to the database through a middle tier;
a cost estimator, wherein the cost estimator is configured to determine the cost of performing an operation on a data source, without actually executing the operation, including cost in terms of estimated disk I/O operations, CPU operations or cycles, number of database rows that would be accessed by the operation, network resource utilization, and memory utilization; and
a cost enforcer module at a middle tier system between the database system and the client system, wherein the cost enforcer module is configured to determine, based on a cost provided by the cost estimator and a predetermined threshold, whether an operation should be executed by the database system.
